(19) United States
(12) Patent Application Publication
(10) Pub. No.: US 2013/0262278 A1
(43) Pub. Date: Oct. 3, 2013

(54) Deduction Information Repository

(71) Applicant: Oracle International Corporation, Redwood Shores, CA (US)

(72) Inventors: Neil Bristow, Farnborough (GB); David Lambert, Paris (FR)

(21) Appl. No.: 13/905,740

(22) Filed: May 30, 2013

Related U.S. Application Data
(63) Continuation of application No. 13/236,624, filed on Sep. 19, 2011.

(51) Int. Cl. G06Q 40/00

(52) U.S. Cl. CPC G06Q 40/10
USPC 705/30

(57) ABSTRACT

A method of using a deduction information repository is disclosed. In one embodiment, the method includes retrieving a template from one or more repositories, modifying the template, and storing the template in the repository. Further, the template is an abstract representation of a payroll task, which is a payroll task that is included in a payroll procedure. The payroll task, in turn, includes a payroll operation of a plurality of payroll operations.

### CROSS-REFERENCE TO RELATED APPLICATIONS

This application is a continuation of U.S. patent application Ser. No. 13/236,624, entitled “Deduction Information Repository”, filed Sep. 19, 2011, naming Neil Bristow and David Lambert as inventors, which claims the domestic benefit under Title 35 of the United States Code §119(e) of U.S. Provisional Patent Application Ser. No. 61/384,262, entitled “Deduction Information Repository,” filed Sep. 18, 2010, and naming Neil Bristow and David Lambert as the inventors. The above—identified applications and their disclosures are incorporated herein by reference for all purposes as if completely and fully set forth herein.

### FIELD OF THE INVENTION

This invention relates to computing and, more particularly, to calculating deductions in a computing system.

### DESCRIPTION OF RELATED ART

Historically, programs have been written to provide specific functionality to specific customers. These historic programs were hard-coded to include this functionality, as well as any baseline data required to support that functionality. Whenever a customer needed new functionality or new baseline data, the program would need to be updated by a programmer. Unfortunately, this approach has proven inflexible.

### BRIEF DESCRIPTION OF THE DRAWINGS

A more complete understanding of the present invention may be acquired by referring to the following description and the accompanying drawings, in which like reference numbers indicate like features.

FIG. 1 illustrates a block diagram of a system that includes a deduction information repository (DIR), according to one embodiment.

FIG. 2 (made up of FIGS. 2A and 2B) illustrates an example data model that supports deduction information repository (DIR), according to one embodiment.

FIG. 3 illustrates an example data model that can be employed in one embodiment.

FIG. 4 is an example of a screenshot showing a user interface to access a DIR, according to one embodiment.

FIG. 5 is an example of a screenshot showing a user interface to create a deduction in the DIR, according to one embodiment.

FIG. 6 is an example of a screenshot showing a user interface to manage an element in the DIR, according to one embodiment.

FIG. 7 is an example of a screenshot showing a user interface to manage an auto-indirect in the DIR, according to one embodiment.

FIG. 8 is an example of a screenshot showing a user interface to create and/or update a taxability rule and/or wage basis rule in the DIR, according to one embodiment.

FIG. 9 is an example of a screenshot showing a user interface to manage the taxability rules and/or wage basis rules applicable for the deductions of a selected group in the DIR, according to one embodiment.

FIG. 10 is an example of a screenshot showing a user interface to create or update a deduction range and associated range items in the DIR, according to one embodiment.

FIG. 11 is an example of a screenshot showing a user interface to create or update calculation units and/or factors in the DIR, according to one embodiment.

FIG. 12 is an example of a screenshot showing a user interface to review the calculation units and/or factors applicable to the deductions in a selected deduction group in the DIR, according to one embodiment.

FIG. 13 is an example of a screenshot showing a user interface to create or update tax reporting units in the DIR, according to one embodiment.

FIG. 14 is an example of a screenshot showing a user interface to create or update overrides using deduction cards in the DIR, according to one embodiment.

FIG. 15 is a block diagram of a computing device, illustrating how a system that includes a DIR can be implemented in software in at least one embodiment.

While the invention is susceptible to various modifications and alternative forms, specific embodiments of the invention are provided as examples in the drawings and detailed description. It should be understood that the drawings and detailed description are not intended to limit the invention to the particular form disclosed. Instead, the intention is to cover all modifications, equivalents and alternatives falling within the spirit and scope of the invention as defined by the appended claims.

### DETAILED DESCRIPTION

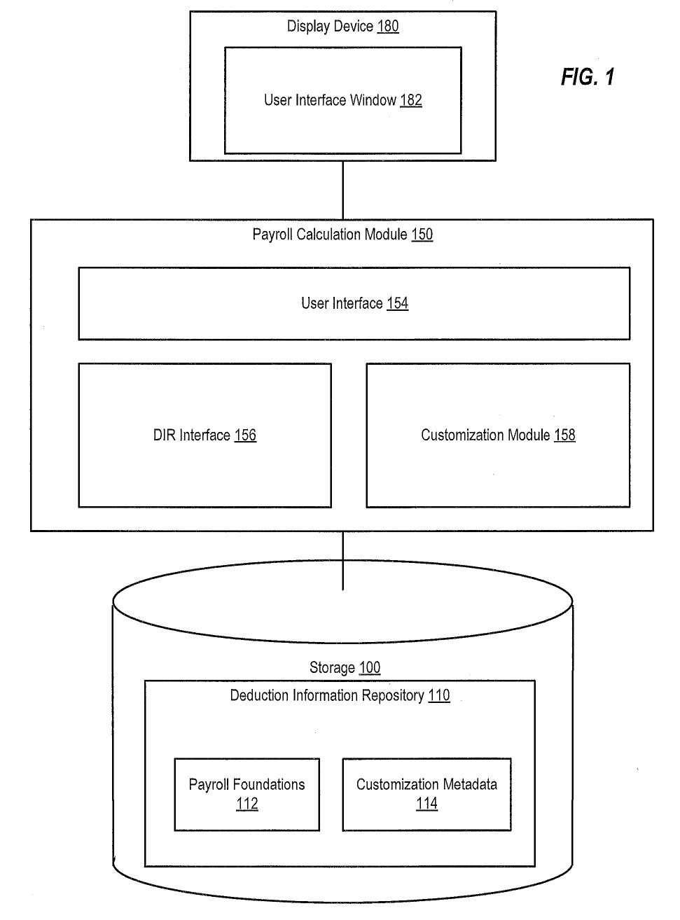

FIG. 1 illustrates a block diagram of a system employing one embodiment of a deduction information repository (DIR). As shown, the system includes a payroll calculation module 150 that is coupled to a display device 180 and a storage device 100. The payroll calculation module 150 includes a user interface 154, which generates a user interface window 182 for display on display device 180, a DIR interface 156 for accessing a DIR 110 stored on storage device 100, and a customization module 158 for processing information retrieved from DIR 110 for inclusion in information displayed in user interface window 182. DIR 110 includes payroll foundation information (“payroll foundations”) 112 that is centrally managed for the entire organization, as well as customization metadata 114 (e.g., provided in the form of deduction cards, as described in more detail below) that allows consumers to customize the payroll foundation information for a specific localization.

Storage device 100 provides persistent data storage, such that data stored on such a storage device will remain stored even after the storage device is powered off. Such a storage device can be, for example, a hard disk, a compact disc (CD), a digital versatile disc (DVD), or other mass storage device, or a storage system (e.g., a redundant array of independent disks (RAID) system or an optical storage jukebox) that includes an array of such storage devices. Such a storage device can also be a virtual or logical storage device that is implemented on such physical storage devices and/or storage systems. For example, such a storage device can be a logical volume that is implemented on a RAID storage system. Additionally, such a storage device can include one or more storage devices. A storage device can also include one or more types of storage media, including solid state media (e.g., Flash drives), optical media (e.g., CDs and DVDs), and magnetic media (e.g., hard disks or magnetic tape). In some embodiments, such storage devices can be implemented using cloud storage, in which the storage device is a logical storage device to which physical storage device(s) are allocated on an as-needed and/or as-contracted basis.

Display device 180 is configured to display graphical and/or textual information to a user. A display device can include an output-only device such as a cathode ray tube (CRT), liquid crystal display (LCD), or plasma monitor. Alternatively, a display device such as a touch screen display can provide both input and output functionality, allowing a user to interact with payroll calculation module 150 directly via the display device.

Display device 180, payroll calculation module 150, and storage 100 can be coupled directly (e.g., via a bus, local wireless link, or other appropriate interconnect) or indirectly (e.g., via a network). In one embodiment, these elements are each coupled by one or more networks, which may include a WAN (Wide Area Network), such as the Internet, one or more LANs (Local Area Networks), and/or one or more SANs (Storage Area Networks).

DIR 110 and payroll calculation module 150 are configured to let consumers define calculation rules and values for particular localizations. These calculation rules and values can include those for calculating statutory deductions, including taxes, social insurance, loans, pension plans and more.

DIR 110 provides a potentially global infrastructure capable of storing all deduction related rules and values for legislative and personal employee data. This infrastructure provides a centralized and consistent way to manage these rules and values in a single global user interface and enables payroll calculation module 150 to process their details in an efficient manner. The infrastructure also provides a mechanism to allow some values (e.g., rates, flat amounts, and parameters) to be overridden at various levels.

The main consumers of DIR 110 can be localizations (e.g., specific offices of a corporation that are located in different political regions of a particular state, a particular country, and/or the world) which would like to customize the way deductions are calculated to be specific to their particular localization. For instance, use of the DIR allows several formula result rules in a generic formula to be replaced by auto-indirects, the integration of taxability rules that simplify or replace several fast formulas, the replacement of fast formulas with calculation units/factors, and the use of value definitions (deduction ranges) to store calculation values instead of global values, user-defined tables, or bespoke tables. The use of DIR 110 can also allow fast formulas to include loops, arrays and array database items, nested fast formulas, and also balances.

User of DIR 110 provides consumers and users a centralized (e.g., company-wide or region-wide) and consistent way to manage calculation rules and calculation values. User interface 154 is configured to let consumers control, update, and enter not only calculation rules, but also all the values required for the calculation of deductions (e.g., rates, flat amounts, and parameters). Because data required for the calculations is stored in a single repository (the DIR) controlled by core payroll (rather than being stored in many different mechanisms, each designed for each consumer's localization), the payroll calculation module 150 can also implement caches (not shown) that improve calculation speed.

In addition, use of DIR 110 provides a mechanism to allow some values (rates, flat amounts, but also parameters) to be overridden at various levels. In one embodiment, this functionality is provided by data structures referred to as deduction cards that can be set up for different purposes (e.g., such as tax, social security, or pension information at the employee or payroll relationship level; or such as payroll information including values at organization level). This mechanism can provide a consistent and centralized way to define and store calculation values while also providing high performance (e.g., due to being able to use caches as described above).

Moreover, the introduction of deductions can be considered when designing element templates, because the templates designed for customers can include deductions. While most the deductions may be delivered by localizations as part of statutory calculations, several templates that include one or more deductions may be provided, depending on the requirements.

Payroll calculation module 150 can be configured to perform a variety of tasks to configure DIR 110. An uptake task can be broadly categorized as any of: identification of elements and calculations to be re-engineered using the DIR; definition of deductions with appropriate contexts and/or references to be used for taxability rules and/or wage basis rules and calculation units and/or factors; attachment of elements to deductions; definition of taxability rules/wage basis rules; definition of sets of values and deduction ranges with appropriate calculation types to be used by the calculations; definition of calculation methods and calculation parts; definition of calculation units and/or factors; attachment of deductions to tax reporting units; definition of overrides and integration with deduction cards; and introduction of deductions into element templates.

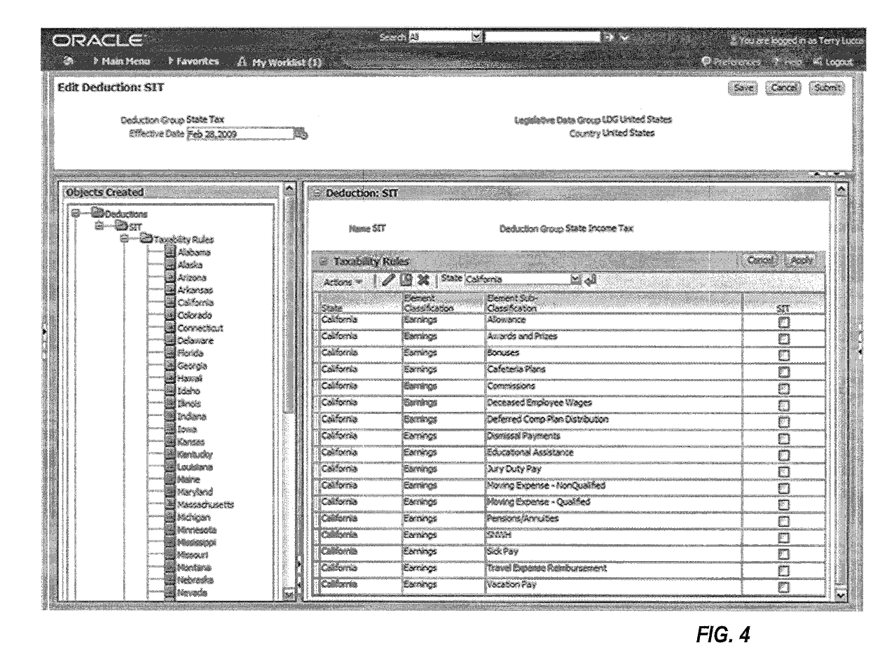

The user interface (e.g., user interface 154 of FIG. 1) of DIR 110 can be based on a framework designed by core payroll for element definitions. This framework can include multiple pages that are split into 3 areas: a header (“Edit Deduction:SIT” in this example, where SIT stands for state income tax), a tree (“Objects Created” in this example), and a page fragment (“Deduction:SIT”), as shown in the example of FIG. 4.

The header represents the object the user is focusing on (e.g., element, deduction (as in the example of FIG. 4), deduction group, or deduction range). Payroll data (including elements, deductions, and deduction ranges) are partitioned by legislation code or legislative data group. All the payroll tables that represent business objects can include the columns LEGISLATION_CODE and LEGISLATIVE_DATA_GROUP_ID. Localizations seed data for a specific legislation code. Customers enter data for a specific legislative data group. The user interface displays (within headers on the top of pages, such as “LDG United States” in the header of FIG. 4) the legislation or the legislative data group of the object for which it is defined.

A tree, such as that shown in the lower left corner of FIG. 4, can be used in order to provide navigation through all the items that are attached (directly or indirectly) to the object the user is focusing on. For instance, the user can have access to the input values of one element, to the taxability rules and/or wage basis rules defined for one deduction, to the calculation units and/or factors defined for one element, and so on. This object navigator is also designed in order to provide shortcuts for filtering data. The tree displays the context and/or reference values (in a hierarchical order) that are defined for taxability rules and/or wage basis rules and calculation units and/or factors. This way, the user can select a context and/or reference value from the tree in order to display the taxability rules and/or wage basis rules or calculation units/factors defined for the selected context/reference value. A page fragment, like that in the lower right corner of FIG. 4, can show the details of the data selected in the object navigator.

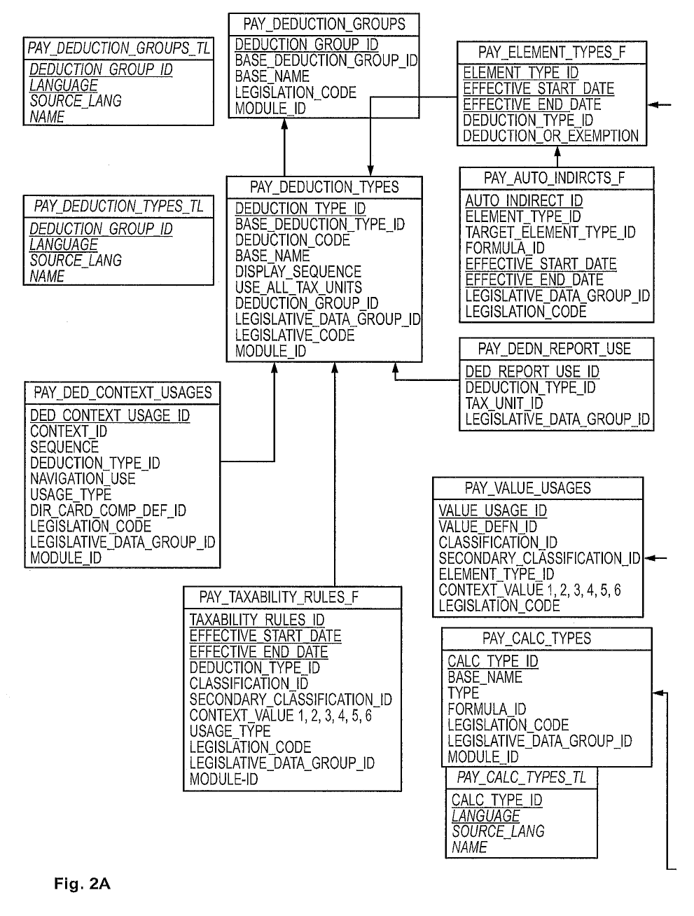

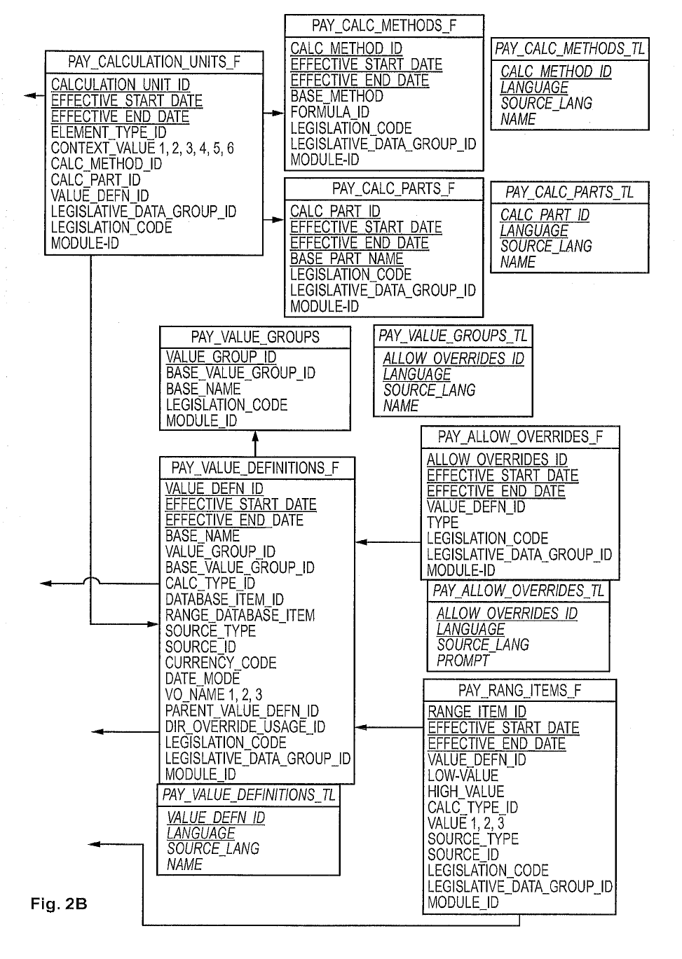

Referring back to FIG. 1, DIR 110 can be implemented as a plurality of tables (e.g., implemented according to the data model shown in FIG. 2, as described below). In one embodiment, almost all of the tables included in the DIR contain payroll foundation information 112, which includes data seeded by core payroll, as well as customization metadata 114, which includes customer data and/or localization-specific information.

In one embodiment, the data model (shown in FIG. 2, which is made up of FIGS. 2A and 2B) that supports the DIR 110 includes three logical business areas: deductions.setup, deductions.values and elements. setup.

In the embodiment illustrated in FIG. 2, the logical business area deductions.setup includes PAY_DEDUCTION_TYPES, PAY_DEDUCTION_TYPES_TL, PAY_DED_CONTEXT_USAGES, PAY_TAXABILITY_RULES_F, PAY_CALC_TYPES, PAY_CALC_TYPES_TL, PAY_CALC_METHODS_F, PAY_CALC_METHODS_TL, PAY_CALC_PARTS_F, PAY_CALC_PARTS_TL, PAY_CALCULATION_UNITS_F, PAY_DEDN_REPORT_USES, PAY_DEDUCTION_GROUPS, and PAY_DEDUCTION_GROUPS_TL.

Deductions are defined with contexts and/or references to be used for taxability rules and/or wage basis rules and calculation units/factors. Deductions are identified in the system by a name and they are made of three parts: taxability rules and/or wage basis rules, calculation units and/or factors through elements, and tax reporting units. Each deduction is attached to a deduction group.

Taxability rules and/or wage basis rules and calculation units and/or factors are defined based on criteria that are represented by contexts and/or references. Contexts and/or references used for taxability rules and/or wage basis rules and calculation units and/or factors can be different. In one embodiment, each set can include up to six contexts and/or references. Contexts and/or references are defined at deduction level, thus they can vary from one deduction to another (even in the same deduction group). However, the calculation units and/or factors that are broken down by elements are all based on the same contexts and/or references. Contexts and/or references are managed by core payroll in a centralized way (table FF_CONTEXTS) and are consumed depending on legislation or legislative data group (table PAY_CONTEXT_USAGES). This way, localizations can define meanings and lists of values (using lookups or view objects) for the contexts and/or references they want to use, for instance: National Insurance Category, Department, Job Type, Tax Reporting Unit, and the like. However, customers can also define their own contexts and/or references. The view objects required for the display of list of values is provided by localizations, can be based on any table or view (for instance hz_geographies), registered into PAY_CONTEXT_USAGES, and follows the same standard.

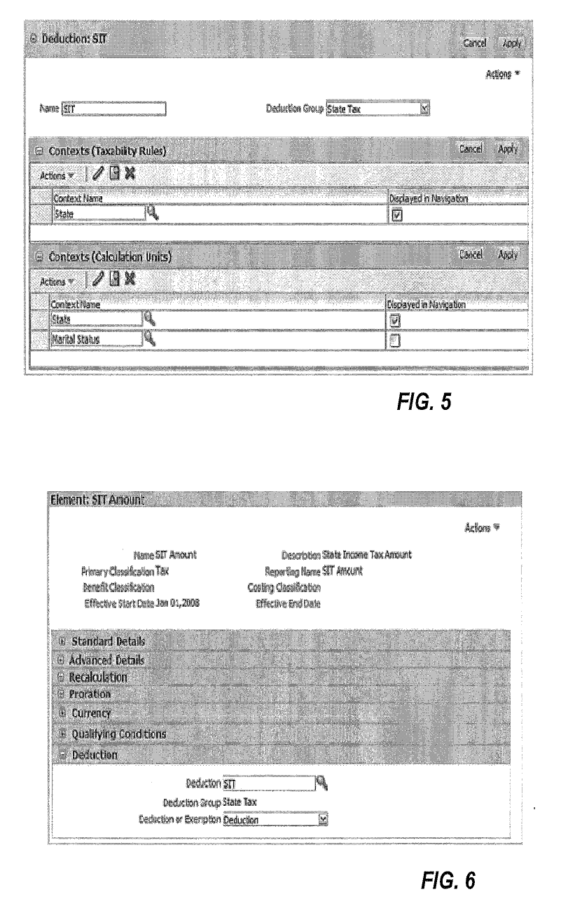

A deduction can be created in the DIR using the user interface through the “Manage Deductions” task, as illustrated in the example screenshot of FIG. 5. As shown, the user interface can include in the first page the reference to the deduction group and the contexts/references to be used for taxability rules/wage basis rules and for calculation units/factors.

Deductions let consumers define calculation units and/or factors for sets of elements. One element can be attached to one (and only one) deduction. Then, the calculation units/factors are defined element by element within a deduction. In addition, such an element can be specified as a deduction element or an exemption element. This way, elements become components of the deduction (for instance: exemption 1, exemption 2, value, rebate 1, rebate 2, and so on). The contexts and/or references defined at the deduction level are applicable for all the calculation units and/or factors defined for every element. This allows the design of deductions to be broken down by elements in a consistent way because they share the same contexts and/or references.

In addition, the sequence of calculations can be setup using auto-indirects, which can avoid the need for formula result rules for many calculations of elements. An auto-indirect creates a simple relationship between one element and another target element. Multiple auto-indirects, thus multiple targets, can be defined for one element. This is used for instance when a calculation starts with an initial element that generates multiple elements (e.g., values, exemptions, rebates). Typically calculations will be based on a deductable amount, then exemptions that give a reduced deductable amount, then a deducted amount that performs the calculation of the deduction.

Plus, the generation of indirects can be dynamic, using a fast formula. This lets deduction processing be defined for multiple criteria. The fast formula is used in order to trigger various calculations of the same element but using different context and/or reference values. The payroll run will match the return variable name with a context and/or reference name, thus setting the context and/or reference value. The fast formula may return simple data types or complex data types (arrays). However, if multiple array data types are returned, the same number of entries will exist in each array. If a combination of arrays and simple data types are used then the value of the simple data type will be used for each entry in the array. The calculations of deductions are not driven by the deductions but by the elements, formula result rules, and auto-indirects.

Elements can be attached to deductions using table PAY_ELEMENT_TYPES_F. Auto-indirects can be defined with a fast formula for dynamic indirects using table PAY_AUTO_INDIRECTS_F.

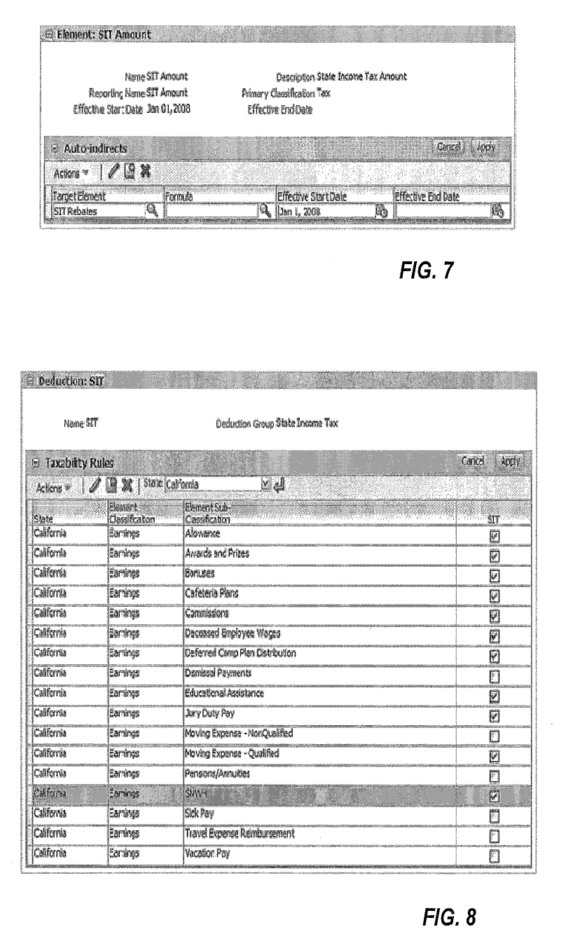

An element can be created or updated using the user interface through the “Manage Elements” task, as shown in FIG. 6. The element detail page includes a reference to a deduction, and the deduction or exemption flag. In some embodiments, this user interface is display-only, and the element information is instead seeded by localizations or is managed thought element templates. Auto-indirects can be managed in the same component, as shown in FIG. 7.

Because the base of calculation for a deduction (deductable amount) can vary depending on criteria (a state code for instance), the concept of taxability rules and/or wage basis rules introduces a way to identify variations on the calculation of balances based on context and/or reference values, according to the contexts and/or references selected at the deduction level. The taxability rules and/or wage basis rules table defines for a deduction what are the classifications and secondary classifications of the run results to be considered in the determination of balance values for a combination of context values. The taxability rules and/or wage basis rules can be defined for each deduction in table PAY_TAXABILITY_RULES_F.

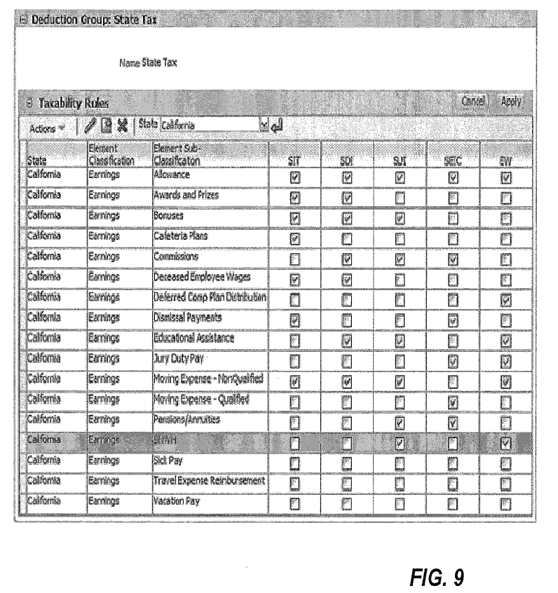

Taxability rules and/or wage basis rules can be created or updated using the user interface through a “Manage Deductions” task, as shown in FIG. 8. This task can include references to context values, according to the contexts and/or references defined at deduction level, classifications, and secondary classifications. The task “Manage Deduction Groups” allows users to review, in a single page, all the taxability rules and/or wage basis rules applicable for the deductions of a selected group, as shown in FIG. 9.

Deduction ranges are not only sets of values but are considered as basic building blocks of calculations, as they are associated with one or more calculation types. Deduction ranges (tables PAY_VALUE_DEFINITIONS_F and PAY_VALUE_DEFINITIONS_TL), which are attached to range groups (tables PAY_VALUE_GROUPS and PAY_VALUE_GROUPS_TL), can be defined with the appropriate values (e.g., range items in table PAY_RANGE_ITEMS_F) and calculation types (e.g., by defining custom calculation types with a fast formula in tables PAY_CALC_TYPES and PAY_CALC_TYPES_TL), plus additional calculation types if desired, to be used by calculation units and/or factors. In addition, database items can be used as parameters or flags, or to define deduction range values dynamically. Thus, a deduction range can define one single amount (e.g., a flat amount, a rate, or percentage), or an unlimited number of amounts that are retrieved based on low and high values (as limits or bands), in a static or dynamic way (dynamic bands expressed as percentages of one database item). One calculation type is defined by default for the whole calculation, but each item (each band) can override the calculation type by specifying another. During uptake, the existing global values, user defined tables, rates by criteria, and bespoke tables (including tables used to store overrides) or other functionalities (including literal values used in fast formulas) can be considered. In addition, most of basic calculation (such as “base×rate”) provided by fast formulas in the existing designs can be simplified. Basically, fast formulas can be attached to calculation methods and the basic bricks of calculations (such as “base×rate”) can be managed through the calculation types.

Calculations can be based on a core function CALC_DIR_VALUE that performs the basic calculations depending on the calculation types. Consumers can access this core function indirectly using formula CALL_CALC_VALUE. In one embodiment, the formula has the following parameters: base (number), which is the value to be operated on (deductable amount); range_value (number-optional), which is to be used in order to determine the appropriate range item; calculation_factor (number-optional), which is used as a multiplying factor for certain calculations; range_offset (number-optional), which will typically be used with the “Graded” calculation types; range_low_override (number, number array-optional); and/or range_high_override (number, number array-optional). The formula returns the calculated amount ded_amount based on calculation types.

The appropriate value definition (deduction range) to be used for the calculations is determined by the combinations of calculation method, calculation part/step and context values through the calculation units/factors attached to an element. In one embodiment, the following calculation types are seeded by core payroll: flat amount: constant value; flat amount times multiplier: constant value multiplied by a database item; conditional flat amount: constant value that depends on a database item; flat rate: percentage of a balance, applied on the total; incremental rate: percentage of a balance, graded by bands; standard formula 1: y=Ax−Bz, where y is the deducted amount, x is the reduced deductable amount, A is a value supplied by the legislation, B is a value supplied by the legislation, and z is a factor defaulted to 1 supplied from a formula; standard formula 2: y=(x−A)×B+Cz, wherein y is the deducted amount, x is the reduced deductable amount, A is a value supplied by the legislation, B is a value supplied by the legislation, C is a value supplied by the legislation, and z is a factor defaulted to 1 supplied from a formula; text: character string values; and/or graded calculation and total calculation: used to link range items to other value definitions (deduction ranges) in order to record a single rate or amount, when that rate or amount can be used in more than one value definitions (deduction range).

As an example, consider two tax categories: Tax Category 1, in which payroll ranges 0 to 1000 use SPECIAL_RATE, 1001 to 10000 use STANDARD RATE, and 10001 to 999999999 use ENHANCED RATE; and Tax Category 2, in which payroll ranges 0 to 1000 use ENHANCED_RATE, 1001 to 10000 use SPECIAL_RATE, and 10001 to 99999999 use STANDARD RATE. In this example, the user does not want to maintain the STANDARD_RATE multiple times in different value definitions (payroll ranges). Accordingly, the user can use either the graded or total calculation, in which case the value1 column contains the Value Definition ID to be used for that range.

In formula CALL_CALC_VALUE, range offsets can be used with the “Graded” calculation types. The function CALC_DIR_VALUE takes a value called range which is used to work out how to calculate the value. For example, using Tax Category 2 from above, if the range passed is 2200, the calculation will be 1000 at ENHANCED_RATE and 1200 at SPECIAL_RATE. However the range offset allows the caller to take into account any previous calculations performed that could affect the range. For example, a tax can be split into Tax Category 1 and Tax Category 2, both of which share a “free pay limit”. Thus, Tax Category 1 may have already accounted for 500 of the range. Accordingly, the calculation is passed a range offset of 500 hence the result becomes 500 at ENHANCED RATE and 1700 at SPECIAL RATE.

If the calculation types provided by core payroll do not fit the requirements of the localizations, then additional calculation types can be defined with an appropriate fast formula. This way, parts of some fast formulas can be reused in order to define new calculation types. The fast formulas (defined with the specific type “Payroll Calculation Type”) do not require parameters as they will be based on global variables. In that case, the calculation types are marked as ‘Custom’. However, localizations can first gain approval from core payroll to ensure that there is a consistent approach and the new calculation type does not have a global impact.

In order to specify the usage or restrictions of one deduction range against calculation factors/units, localizations can define for which combination of context and/or reference values one deduction range is available on a calculation units and/or factors page. This configuration applies to one single element or one element classification or secondary classification. This way, the system filters the list of available deduction ranges in calculation factors/units pages, depending on the element and the context/reference values. Consumers can make use of the formula GET_CALC_DETAIL, which returns information used in the last calculation: internal_calc_type, outer_calc_type, low_value, high_value, base, rate, flat_amount, multiplier, parameter, value_a, value_b, value_c, val_def_name, and/or override_flag. Override_flag returns ‘ ’ or the override type used during the calculation.

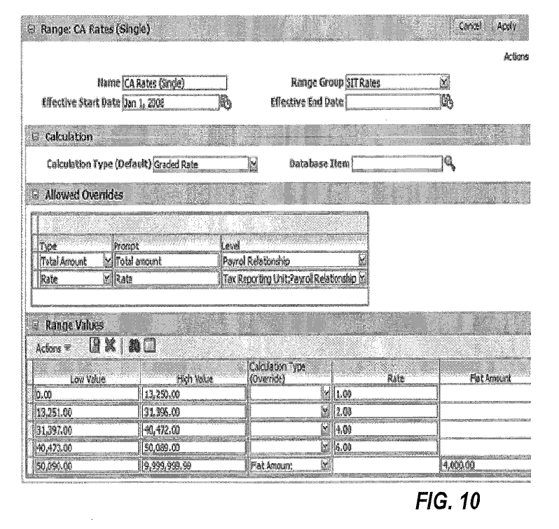

A deduction range with associated range items can be created or updated using the user interface through the “Manage Deduction Ranges” task, as shown in FIG. 10. It includes references to a range group, calculation types and database items. In addition, range groups can be added through the same user interface. The following columns can be displayed in the table based on the selected calculation type in PAY_CALC_TYPES (described below): F: flat amount: Flat Amount; G: incremental rate: Percent; T: flat rate: Percent; C: custom: none; S1: standard formula 1: A and B; S2: standard formula 2: A, B and C.; FM: flat amount times multiplier: Flat Amount; FP: conditional flat amount, Parameter Value, Flat Amount; X: text: Value.

Calculation methods are defined in order to identify fast formulas and are referenced in calculation units/factors. Calculation methods can be defined, and the parts and/or steps to be used in the calculations identified, by defining the calculation methods that reference fast formulas (in tables PAY_CALC_METHODS_F and PAY_CALC_METHODS_TL), and the calculation parts and/or steps (in tables PAY_CALC_PARTS_F and PAY_CALC_PARTS_TL).

Those fast formulas operate at a higher level than the calculation types, and provide a wrapper around the calculations of deduction components (deduction element or exemption element) based on a deductable amount and a deducted amount (given as parameters). Such fast formulas use a core function to trigger retrieval of values (from deduction ranges) and basic calculations (from calculation types). Methods can vary based on various criteria, such as legislation, organization or employee. Thus, a method is referenced in the system by a specific context METHOD_NAME that can be assigned by fast formulas. Several fast formulas are provided by core payroll in order to define standard methods of calculation. Localizations can also define additional methods based on specific fast formulas (defined with the type “Payroll Calculation Method”) that may use the core payroll fast formulas. However, such localizations should agree with core payroll policies, to ensure consistency across localizations.

Such fast formulas can require four parameters: the calculation amount (reduced deductable amount) that is the value to be operated on; the deduction amount taken so far in the applicable period; the range amount to be used in order to determine the appropriate range item; and a calculation factor that is used as a multiplying factor for certain calculations. The returned value is the amount to be deducted in the current run. Such fast formulas make use of the function CALC_DIR_VALUE that executes the basic calculation based on a deduction range (for the values) and a calculation type (for basic building blocks of calculation, such as ‘base×rate”).

The following calculation methods are seeded by core payroll: Cumulative (formula CORE CUMULATIVE); Periodic (formula CORE PERIODIC); Annualized (formula CORE ANNUALISED); Independent (formula CORE INDEPENDENT).

Calculation parts allow complicated calculations to be split, when multiple value definitions (deduction ranges) and calculation types are required for the calculation of one element. If for instance a calculation is the combination of an ‘incremental rate’ plus a ‘flat amount times a multiplier, then two sets of deduction ranges can be defined separately and then identified in the calculation units/factors as two parts. Calculation parts are identifiers defined by consumers, referenced in the calculation units/factors and managed as a context PART_NAME by the system. The appropriate value definition (deduction range) to be used for the calculations is determined by the combinations of calculation method, calculation part/step, and context values through the calculation units and/or factors attached to an element.

Calculations units define for a specific element (deduction element or exemption element) the value definitions (deduction ranges), and thus the appropriate calculation type to be used based on calculation methods, calculation parts and combinations of context values. Calculation units and/or factors can be defined for elements by defining the calculation units/factors for deduction or exemption elements, based on calculation methods, calculation parts/steps and combination of context values, with references to deduction ranges in table PAY_CALCULATION_UNITS_F.

The calculation methods referenced in calculation units/factors could be generic core methods, or specific methods. The combinations of context values do not need to include all the contexts/references defined at deduction level, only a few of them can define a valid calculation unit/factor. For instance context 2 may be required for only a few values of context 1.

The calculation units/factors are used by the system when the function CALC_DIR_VALUE is triggered. The following algorithm is implemented: the calculation units/factors are identified based on the element being processed; the calculation part/step is used, if set; the calculation method is used if set; the context values 1 through 6 are used in priority order, if set.

The function CALC_DIR_VALUE looks at the calculation unit/factor, first using the calculation method and all context values. If no calculation unit/factor matches the criteria, the system looks at the calculation unit/factor with all context/reference values but with no calculation method. Then, if no calculation unit/factor matches the criteria, the system repeats the process: it looks at the calculation unit/factor with less context/reference values with the calculation method, and then with the no calculation method.

For example, if an entry is being processed associated with the deduction “State Income Tax”, in which contexts/references “State” and “Marital Status” set as priority 1 and 2 respectively, and the calling formula has set the contexts/references PART_NAME to ‘A’, METHOD_NAME=‘Annualized’, State=‘CA’ and Marital Status=‘Single’, then the CALC_DIR_VALUE function will search the calculation units/factors in the following order, then stop at the first one that matches:

| Calculation | Calculation | Context 1: | Context 2: Marital |
|---|---|---|---|
| part/step | method | State | Status |
| A | Annualized | CA | Single |
| A | | CA | Single |
| A | Annualized | CA | |
| A | | CA | |
| A | Annualized | | |
| A | | | |

Fast formulas could be designed this way (in the example below there is no method but 2 parts/steps are used in order to manage 2 deduction ranges):

Set context PART_NAME = “A”;
Execute CALC_DIR_VALUE(EARNINGS_PTD,
EARNINGS_PTD, 1)

returning amount1

Set context PART_NAME = “B”;
Execute CALC_DIR_VALUE(EARNINGS_PTD,
EARNINGS_PTD, 1)

returning amount2

Return amount1 + amount2

Fast formulas may also call appropriate calculation method fast formulas (using balances that may be impacted by taxability rules/wage basis rules as parameters for deductable and reduced deductable amounts) and pass the result back to the run result.

Set context METHOD_NAME = Employee_Tax_Method;
If METHOD_NAME = “Cumulative” then

Execute CORE_CUMULATIVE(
SIT_Reduced_Deductable_YTD, SIT_Amount_YTD)
returning amount

Else if METHOD_NAME = “Annualized” then

Execute CORE_ANNUALIZED(
SIT_Reduced_Deductable_PTD,
SIT_Amount_PTD)
returning amount

End if
Return amount

The calculation method fast formulas may also be provided by a database item that is based on calculation units/factors. Such a fast formula could be designed this way (the example below is the same as the previous one except the calculation method fast formula is retrieved using a database item from the calculation units/factors):

Set context METHOD_NAME = Employee_Tax_Method;
Deduction_Formula = Formula_from_DIR
If METHOD_NAME = “Cumulative” then

Deductable = SIT_Reduced_Deductable_YTD
Range_Value = SIT_Amount_YTD)

Else

Deductable = SIT_Reduced_Deductable_PTD
Range_Value = SIT_Amount_PTD

End if
Execute Deduction Formula (Deductable, Range_Value)
returning amount
Return amount

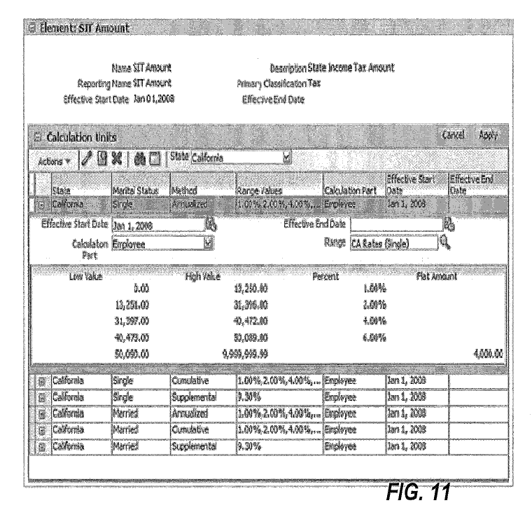

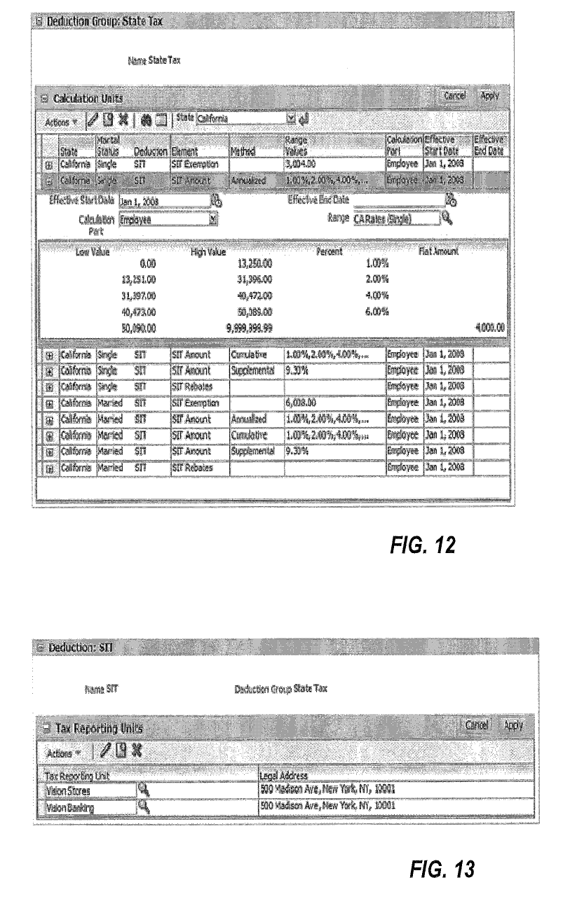

Calculation units/factors can be created or updated using the user interface through the “Manage Deductions” task, as shown in FIG. 11. The “Manage Deductions” task includes references to context values, according to the contexts/references defined at the deduction level, calculation methods and parts, and deduction ranges. In addition, the task “Manage Deduction Groups”, shown in FIG. 12, allows users to review, in a single page, all the calculation units/factors applicable for the deductions of a selected group.

The reporting of deductions is usually broken into tax reporting units, within payroll statutory units. For example, in some jurisdictions, one employee is assigned to one tax reporting unit, and deductions for a single employee are all reported within the same organization. In other jurisdictions, deductions for a single employee are reported using different tax reporting units. In that case, appropriate tax reporting units can be attached to deductions. As an example, in an Indian localization, tax reporting units can be setup per regions or areas for the reporting of professional taxes, others for income taxes. Those tax reporting units will report separately appropriate deductions. To attach the tax reporting units to each deduction, the tax reporting units to be used for the reporting of deductions can be defined in table PAY_DEDN_REPORT_USE. Tax reporting units can be created or updated using the user interface through the “Manage Deductions” task, as shown in FIG. 13.

Deduction cards provide a mechanism to capture information required for payroll calculations at various levels below legislation level (e.g., at Payroll Statutory Unit level, Tax Reporting Unit level or Payroll Relationship level). This information, mainly based on flex field definitions, is then used by the payroll through database items. But in addition, some information referenced into the cards can be defined as overrides of legislative values. Overrides are defined into deduction cards by defining the allowed overrides on deduction ranges in tables PAY_ALLOW_OVERRIDES_F and PAY_ALLOW_OVERRIDES_TL.

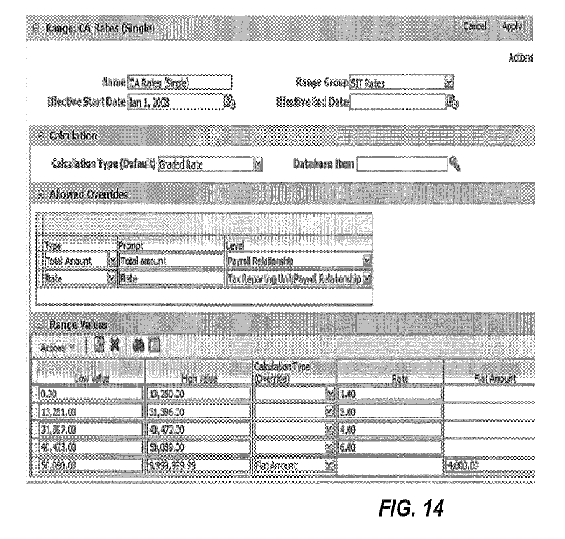

Overrides can be created or updated using the user interface through the “Manage Deduction ranges” task, as shown in FIG. 14. The deduction cards will show a collection of attributes that are defined primarily by flex fields. In addition, some attributes may refer to overrides. In that case, those attributes will be displayed the same way as the others (using flex fields), except for the labels that come from the ‘Prompt’ column defined at ‘Allowed Overrides’ level. If for instance a deduction range that represents a tax exemption is defined as a flat amount, then the legislation may allow the override of the exemption at person level. In that case, the prompt column could be defined with “Personal Tax Exemption”. The deduction card will display an attribute that lets users enter a value referenced as “Personal Tax Exemption”. For a technical stand point, the system will store the value of the override as a range value into PAY_RANGE_ITEMS_F.

One difference is made when an override is allowed with the type “Range table”. In that case the override is not a single amount but a table. For this type of override, the user interface will display an icon that shows a popup window used to enter a table of amounts.

Two kinds of overrides can be defined in the system: the value returned by a database item referenced in a deduction range can be overridden by a value entered in a card. For instance, a number of children defined as a database item to the HR database could be overridden in a deduction card; Legislative values defined as part of a deduction range (percentages, flat amounts, and the like) can be overridden in a deduction card. In that case, the overrides can be entered in various ways: all the range items can be overridden by another set of range items (range table) entered in the deduction card; one component or more of a range item (percentage, flat amount, and the like) can be overridden by a value entered in a deduction card; the whole range can be overridden by a total amount entered in the deduction card. An additional amount can be entered in the deduction card. Multiple overrides can be entered and for each of them a prompt string is entered: this prompt will be displayed in the deduction card in order to enter the override amount.

In one embodiment, if multiple overrides are entered for the same deduction range, then the system will apply one of them in the following priority: Total amount at payroll relationship level; Total amount at payroll statutory unit level; Total amount at payroll tax reporting unit level; Range table at payroll relationship level; Range table at payroll statutory unit level; Range table at payroll tax reporting unit level; Value component (percent) at payroll relationship level; Value component (percent) at payroll statutory unit level; and Value component (percent) at payroll tax reporting unit level.

In one embodiment, when allowing overrides, at least one record exists in PAY_RANGE_ITEMS_F table for the deduction range considered for the override. This can avoid incorrect payroll calculations.

As shown in FIG. 2, PAY_DEDUCTION_TYPES defines a deduction used for taxability rules and/or wage basis rules and calculations through elements based on contexts and/or references. This table can be seeded by core payroll as well as localizations. PAY_DEDUCTION_TYPES_TL is a multiple language support (MLS) table of information used to support PAY_DEDUCTION_TYPES in more than one language. DEDUCTION_TYPE_ID is a surrogate key. BASE_DEDUCTION_TYPE_ID is a reference to a core deduction, which can be used in order to enable deductions to be seeded by core payroll in legislation. DEDUCTION_CODE is the code of the deduction shown in the user interface. BASE_NAME is the name of the deduction used internally for validations. DISPLAY_SEQUENCE is a sequence number used to order deductions within the group the deduction is attached to. DEDUCTION_GROUP_ID is a reference to the deduction group the deduction is attached to. LEGISLATIVE_DATA_GROUP_ID is a reference to a legislative data group (used by customers). LEGISLATION_CODE is the legislation code (used by localizations). MODULE_ID is used by the seed data framework. USE_ALL_TAX_UNITS indicates every tax reporting unit that can report the deduction. Values are TRUE or FALSE. In some embodiments, users can specify a list of tax reporting units (in table PAY_DEDN_REPORT_USE) when this attribute is set to FALSE. Because customers can update seeded data, this column is seeded carefully. If this attribute is set to TRUE, customers are not able to enter specific tax reporting units.

PAY_DED_CONTEXT_USAGES defines the contexts and/or references used by a deduction for taxability rules and/or wage basis rules or calculation units/factors. This table can be seeded by localizations. PAY_DED_CONTEXT_USAGES is a child of PAY_DEDUCTION_TYPES. DED_CONTEXT_USAGE_ID is a surrogate key. CONTEXT_ID is a reference to a context and/or reference. SEQUENCE is a sequence number used for taxability rules and/or wage basis rules or calculation units and/or factors. DEDUCTION_TYPE_ID is a reference to the deduction. Context and/or references can be defined as part of one deduction (e.g., for wage basis rules, calculation factors, and/or deduction cards), but also as part of one deduction card component, independently from a deduction. NAVIGATION_USE indicates the context/reference values will be displayed in the object navigator and as filters attached to tables in the user interface. In one embodiment, when displayed in the navigation, contexts/references are considered as a hierarchy by the system. This means a context/reference with sequence N can be displayed in the navigation only if the context/reference with sequence N−1 is displayed. In that case, the system treats the value of the context and/or reference with sequence N as being dependent on the value of the context and/or reference with sequence N−1, and the values will be displayed as a hierarchy in the object navigator. For example, for the US, the marital status (context 2) can depend on the state code (context 1). In that example, the two contexts/references will be displayed as a hierarchy in the navigation. Values are TRUE or FALSE. USAGE_TYPE indicates the usage of the context and/or reference. Values are T (Taxability Rules/Wage basis rules), C (Calculation Types) or D (Deduction Cards). This information can be used in order to display three separate tables in the user interface. DIR_CARD_COMP_DEF_ID is a reference to a deduction card component. This attribute allows context and/or references to be defined as part of one deduction (for wage basis rules, calculation factors and deduction cards), but also as part of one deduction card component, independently from a deduction. LEGISLATIVE_DATA_GROUP_ID is a reference to a legislative data group (used by customers). LEGISLATION_CODE is a legislation code (used by localizations). MODULE_ID is used by the seed data framework.

PAY_TAXABILITY_RULES_F defines the rules for taxability based on context and/or reference values and element classifications. PAY_TAXABILITY RULES_F can have an effective date that controls the effective dates of the taxability rules encoded within it. The generic columns CONTEXT_VALUE1 through CONTEXT_VALUE6 can store information such as that identifying a jurisdiction, tax type, tax category, and the like. This table can be seeded by localizations. PAY_TAXABILITY_RULES_F is a child of PAY_DEDUCTION_TYPES. TAXABILITY_RULES_ID is a surrogate key. EFFECTIVE_START_DATE is the effective start date. EFFECTIVE_END_DATE is the effective end date. DEDUCTION_TYPE_ID is a reference to the deduction of which this taxability rule is a child. CLASSIFICATION_ID is a reference to an element classification. SECONDARY_CLASSIFICATION_ID is a reference to an element secondary classification. CONTEXT_VALUE1 through 6 provide a value of context 1 through 6. USAGE_TYPE indicates the usage of the taxability rule. Values are P (Processed, meaning the taxability rule is active regarding payroll calculation) or U (User interface, meaning the taxability rule is displayed unchecked in the pages but is not active regarding payroll calculation). In one embodiment, for each combination of context values, one row with a non null CLASSIFICATION_ID and a null SECONDARY_CLASSIFICATION_ID exists in the table (with the appropriate USAGE_TYPE) in order to display the information as desired in pages. This row acts for taxability rules/wage basis rules based on secondary classifications. LEGISLATIVE_DATA_GROUP_ID is a reference to a legislative data group (used by customers). LEGISLATION_CODE is a legislation code (used by localizations). MODULE_ID is used by seed data framework.

PAY_CALC_TYPES defines the types of calculation supported by value definitions (deduction ranges) through a core function or using a custom fast formula. PAY_CALC_TYPES_TL is an MLS table for PAY_CALC_TYPES. This table can contain information seeded by both core payroll and localizations. CALC_TYPE_ID is a surrogate key. BASE_NAME is the name of the calculation type used internally for validations. TYPE defines the type of calculation type. Values are: F: flat amount; G: incremental rate; T: flat rate; C: custom; S1: standard formula 1; S2: standard formula 2; FM: flat amount times multiplier; FP: conditional flat amount; X: text; GC: graded calculation; and/or TC: total calculation. FORMULA_ID is a reference to the fast formula that makes the calculation in case of a custom calculation type. LEGISLATIVE_DATA_GROUP_ID is reference to a legislative data group (used by customers). LEGISLATION_CODE is a legislation code (used by localizations). MODULE_ID is used by the seed data framework.

PAY_CALC_METHODS_F defines methods of calculation supported by specific fast formulas. PAY_CALC_METHODS_TL is an MLS table for PAY_CALC_METHODS. This table can contain information seeded by both core payroll and localizations, as well as user-entered data. CALC_METHOD_ID is a surrogate key. EFFECTIVE_START_DATE is the effective start date. EFFECTIVE_END_DATE is the effective end date. FORMULA_ID is a reference to the fast formula that makes the calculation. BASE_METHOD_NAME is the name of the calculation method used internally for validations. LEGISLATIVE_DATA_GROUP_ID is a reference to a legislative data group (used by customers). LEGISLATION_CODE is a legislation code (used by localizations). MODULE_ID is used by the seed data framework.

PAY_CALC_PARTS_F defines parts and/or steps of a complicated calculation process. PAY_CALC_PARTS_TL is the corresponding MLS table for PAY_CALC_PARTS_F. This table can contain information seeded by localizations and user-entered data. CALC_PART_ID is a surrogate key. EFFECTIVE_START_DATE is the effective start date. EFFECTIVE_END_DATE is the effective end date. BASE_PART_NAME is the name of the calculation part and/or step used internally for validations. LEGISLATIVE_DATA_GROUP_ID is a reference to a legislative data group (used by customers). LEGISLATION_CODE is the legislation code (used by localizations). MODULE_ID is used by the seed data framework.

PAY_CALCULATION_UNITS_F defines the value definitions (deduction ranges) to be used for the calculation of an element attached to a deduction, based on context and/or reference values, calculation methods, and calculation parts and/or steps. This table can contain information seeded by localizations and user-entered data. PAY_CALCULATION_UNITES_F is a child of PAY_ELEMENT_TYPES_F and depends on PAY_VALUE_DEFINITIONS_F. CALCULATION_UNIT_ID is a surrogate key. EFFECTIVE_START_DATE is the effective start date. EFFECTIVE_END_DATE is the effective end date. ELEMENT_TYPE_ID is a reference to the element. CONTEXT_VALUE1 through 6 stores the values of context 1 through 6. CALC_METHOD_ID is a reference to a calculation method. CALC_PART_ID is a reference to a calculation part/step. VALUE_DEFN_ID is a reference to the deduction range. LEGISLATIVE_DATA_GROUP_ID is a reference to a legislative data group (used by customers). LEGISLATION_CODE is a legislation code (used by localizations). MODULE_ID is used by the seed data framework.

PAY_DEDN_REPORT_USES defines the tax reporting units that report the deduction. This table is a child of PAY_DEDUCTION_TYPES. DED_REPORT_USE_ID is a surrogate key. DEDUCTION_TYPE_ID is a reference to the deduction. TAX_UNIT_ID is a reference to a tax reporting unit. LEGISLATIVE_DATA_GROUP_ID is a reference to a legislative data group.

PAY_DEDUCTION_GROUPS defines groups of deductions. PAY_DEDUCTION_GROUPS can store data seeded by core payroll and localizations. PAY_DEDUCTION_GROUPS_TL is the corresponding MLS table for PAY_DEDUCTION_GROUPS. DEDUCTION_GROUP_ID is a surrogate key. BASE_DEDUCTION_GROUP_ID is a reference to a core deduction group (used to enable the particular deduction group for a given localization). BASE_NAME stores the name of the deduction group used internally for validations. LEGISLATION_CODE is the legislation code (used by localizations). MODULE_ID is used by the seed data framework. NAME is the name of the deduction group shown in the user interface.

In the embodiment illustrated in FIG. 2, the logical business area deductions.values includes PAY_VALUE_DEFINITIONS_F, PAY_VALUE_DEFINITIONS_TL, PAY_RANGE_ITEMS_F, PAY_ALLOW_OVERRIDES_F, PAY_ALLOW_OVERRIDES_TL, PAY_VALUE_USAGES, PAY_VALUE_GROUPS, PAY_VALUE_GROUPS_TL.

PAY_VALUE_DEFINITIONS_F defines a set of values or deduction ranges, a reference to a parameter, and a default calculation type for a given legislation or legislative data group. PAY_VALUE_DEFINITIONS_TL is the corresponding MLS table. This information can be seeded by localizations and/or user-entered data and/or may be dependent upon PAY_CALC_TYPES. VALUE_DEFN_ID is a surrogate key. EFFECTIVE_START_DATE is the effective start date. EFFECTIVE_END_DATE is the effective end date. BASE_VALUE_DEFN_ID is a reference to a core deduction range, which is used in order to enable deduction ranges seeded by core payroll in legislation. BASE_NAME is the name of the deduction range used internally for validations. VALUE_GROUP_ID is a reference a range group. CALC_TYPE_ID is a reference to a calculation type and may represent the default value. DATABASE_ITEM_ID is a reference to a database item to be used as a parameter in the calculations. In one embodiment, this attribute is applicable only when the default calculation type is defined with type ‘FM’. RANGE_DATABASE_ITEM is a reference to a database item used to define a dynamic deduction range. In one embodiment, the bands are set as a percentage of the value provided by the database item. When no database item is provided, then the bands are static. SOURCE_TYPE is used to identify the type of data that could be seeded, which can be user-entered or can represent an override value. SOURCE_ID is used to identify the primary key of the object that owns the item in case of override. CURRENCY_CODE identifies the currency code used when the calculation type is defined with type ‘F’ or ‘FP’ or ‘FM’. DATE_MODE indicates the date mode. In one embodiment, supported values are ‘D’ (Date Earned) and ‘E’ (Effective Date). VO_NAME1 through 3 are references to view objects used to display list of values. References may include full package names. The view objects follow the same standard defined for the view objects designed for the display of context and/or reference values. PARENT_VALUE_DEFN_ID is used to identify the primary key of the parent value definition in case of override. DIR_OVERRIDE_USAGE_ID is used to identify a deduction card component in case of override. LEGISLATIVE_DATA_GROUP_ID is a reference to a legislative data group (used by customers). LEGISLATION_CODE is a legislation code (used by localizations). MODULE_ID is used by the seed data framework.

PAY_RANGE_ITEMS_F defines one component of a set of values or deduction ranges including amounts and calculation type for given low and high values. The information in PAY_RANGE_ITEMS_F can be seeded by localizations or user-entered. PAY_RANGE_ITEMS_F is a child of PAY_VALUE_DEFINITIONS_F. RANGE_ITEM_ID is a surrogate key. EFFECTIVE_START_DATE is the effective start date. EFFECTIVE_END_DATE is the effective end date. VALUE_DEFN_ID is a reference to the deduction range. LOW_VALUE: represents the low limit of a band. HIGH_VALUE: represents the high limit of a band. CALC_TYPE_ID is a reference to a calculation type. This is a non-mandatory attribute that represents an override of the calculation type defined at deduction range and/or value definition level. VALUE1 is a value to be considered for use in calculations, and could be a flat amount, percentage, or parameter (A), a parameter value used for “conditional flat amount”, or a text value, depending on the calculation type. VALUE2 is a second value to be considered for use in calculations, depending on the calculation type (could be a flat amount or parameter B or a text value). VALUE3 is a third value to be considered for use in calculations, depending on the calculation type (could be parameter C or a text value). SOURCE_TYPE is used to identify the type of data that could be seeded, that could be user-entered, or that can represent an override value. SOURCE_ID is used to identify the primary key of the object that owns the item in case of override. LEGISLATIVE_DATA_GROUP_ID is a reference to a legislative data group (used by customers). LEGISLATION_CODE is legislation code (used by localizations). MODULE_ID is used by the seed data framework.

PAY_ALLOW_OVERRIDES_F allows overrides to be defined in deduction cards by defines items that can be overridden, with appropriate prompt label, within a set of values or deduction ranges. These overrides can be effective dated and partitioned. PAY_ALLOW_OVERRIDES_F can store data seeded by localizations and/or user-entered data. PAY_ALLOW_OVERRIDES_TL is an MLS table for PAY_ALLOW_OVERRIDES_F. PAY PAY_ALLOW_OVERRIDES_F is a child of PAY_VALUE_DEFINITIONS_F. ALLOW_OVERRIDES_ID is a surrogate key. EFFECTIVE_START_DATE is the effective start date. EFFECTIVE_END_DATE is the effective end date. VALUE_DEFN_ID is a reference to the deduction range. TYPE defines the type of the override. A type is available or not depending on the calculation type defined on the deduction range. Values can include: AA: additional amount (used when the calculation type is ‘Flat Amount’, ‘Flat Amount Times Multiplier’, ‘Conditional Flat Amount’, ‘Flat Rate’, ‘Incremental Rate’); T: total amount (used when the calculation type is ‘Flat amount’, ‘Flat Amount Times Multiplier’, ‘Conditional Flat Amount’, ‘Flat Rate’, ‘Incremental Rate’); R: rate (used when the calculation type is ‘Flat Rate’, ‘Incremental Rate’); F: flat amount (used when the calculation type is ‘Flat Amount’, ‘Flat Amount Times Multiplier’, ‘Conditional Flat Amount); A: A (used when the calculation type is ‘Standard Formula 1’, ‘Standard Formula 2’); B: B (used when the calculation type is ‘Standard Formula 1’, ‘Standard Formula 2’); C: C (used when the calculation type is ‘Standard Formula 2’); M: multiplier (used when the calculation type is ‘Flat amount Times Multiplier’); P: parameter (used when the calculation type is ‘Conditional Flat Amount’); RT: range table (used when the calculation type is ‘Flat Amount’, ‘Flat Amount Times Multiplier’, ‘Conditional Flat Amount’, ‘Flat Rate’, ‘Incremental Rate’); and/or 1: text value (used when the calculation type is ‘Text’). LEGISLATIVE_DATA_GROUP_ID is a reference to a legislative data group (used by customers). LEGISLATION_CODE is a legislation code (used by localizations). MODULE_ID is used by the seed data framework. PROMPT defines the prompt string to be displayed in the deduction cards in order to enter the override amount.

PAY_VALUE_USAGES defines usage of a deduction range based on context values. PAY_VALUE_USAGES can store data seeded by localizations. PAY_VALUE_USAGES is a child of PAY_VALUE_DEFINITIONS_F. VALUE_USAGE_ID is a surrogate key. VALUE_DEFN_ID is a reference to the deduction range. ELEMENT_TYPE_ID is a reference to one element and can be used to specify for which element the deduction range is available on a calculation factors page. CLASSIFICATION_ID is a reference to an element classification and can be used to specify for which elements, through element classifications, the deduction range is available on the calculation factors page. SECONDARY_CLASSIFICATION_ID is a reference to an element secondary classification and can be used to specify for which elements, through element secondary classifications, the deduction range is available on the calculation factors page. CONTEXT_VALUE1 through 6 store the values of context 1 through 6 and specify for which context and/or reference value the deduction range is available on the calculation factors page. LEGISLATION_CODE is a legislation code (used by localizations).

PAY_VALUE_GROUPS defines groups of sets of values or deduction ranges for a given legislation or legislative data group. PAY_VALUE_GROUPS_TL is the corresponding MLS table. This table can store data seeded by localizations as well as user-entered data. VALUE_GROUP_ID is a surrogate key. BASE_VALUE_GROUP_ID is a reference to a core range group, which can be used in order to enable range groups seeded by core payroll in legislation. BASE_NAME is the name of the range group used internally for validations. LEGISLATIVE_DATA_GROUP_ID is a reference to a legislative data group (used by customers). LEGISLATION_CODE is the legislation code (used by localizations). MODULE_ID is used by the seed data framework.

In the embodiment illustrated in FIG. 2, the logical business area elements.setup includes PAY_ELEMENT_TYPES_F and PAY_AUTO_INDIRECTS_F. PAY_ELEMENT_TYPES_F is an element type can be attached to a deduction as a deduction or an exemption. This table can contain information seeded by localizations as well as information entered by a user. ELEMENT_TYPE_ID is a surrogate key. EFFECTIVE_START_DATE indicates the effective start date of the element. EFFECTIVE_END_DATE indicates the effective end date. DEDUCTION_TYPE_ID is a reference to the deduction the element is attached to. DEDUCTION_OR_EXEMPTION specifies the nature of the element. Values can include D (Deduction) or E (Exemption).

PAY_AUTO_INDIRECTS_F defines a target element for automatic indirect generation. This table can contain information seeded by localizations and/or entered by a user and is a child of PAY_ELEMENT_TYPES_F. AUTO_INDIRECT_ID is a surrogate key. ELEMENT_TYPE_ID is a reference to the source element. TARGET_ELEMENT_TYPE_ID is a reference to the target element. FORMULA_ID is a reference to a fast formula, which returns arrays of context and/or reference values and is used for dynamic auto-indirects that expand calculations by criteria. EFFECTIVE_START_DATE is the effective start date. EFFECTIVE_END_DATE is the effective end date. LEGISLATIVE_DATA_GROUP_ID is a reference to a legislative data group (used by customers). LEGISLATION_CODE is the legislation code (used by localizations).

Some of the tables described above may reference tables outside of the specific three logical business areas described in FIG. 2. Such tables can include: FF_CONTEXTS, which stores contexts and/or references defined by core payroll; FF_FORMULAS, which stores fast formulas; FF_DATABASE_ITEMS, which stores database items; PAY_CONTEXT_USAGES, which stores information indicating the usage of contexts and/or references consumers in a particular localization want to use in the DIR; PAY_TAX_REPORTING_UNITS, which stores information identifying tax reporting units; and/or PER_LEGISLATIVE_DATA_GROUPS, which stores information defining legislative data groups.

PAY_CONTEXT_USAGES can include CONTEXT_USAGE_ID, which is a surrogate key; CONTEXT_ID, which is a reference to a core context and/or reference; LOOKUP_TYPE, which is a reference to a lookup used to display a list of values; VO_NAME, which is a reference to a view object (including full package name) used to display a list of values (LOOKUP_TYPE and this information are mutually exclusive); LEGISLATIVE_DATA_GROUP_ID, which is a reference to a legislative data group (used by customers); LEGISLATION_CODE, which is a legislation code (used by localizations); and MODULE_ID, which is used by the seed data framework. PAY_CONTEXT_USAGES can have a corresponding MLS table.

The view objects used for the display of list of values can be provided by localizations, can be based on any table or view (for instance hz_geographies), can be registered into PAY_CONTEXT_USAGES, and can follow the same standard. There can be two view attributes: code (string), which is the code used to identify the context/reference value; and/or meaning (string), which is the meaning of the context/reference value. One view criterion can be used in order to manage a hierarchy (e.g., up to 6 levels) of data. This view criterion can be based on anything available from the view object definition, using the following bind variables: pCodeLevel1: used to select data based on one value at level 1; pCodeLevel2: used to select data based on one value at level 2; pCodeLevel3: used to select data based on one value at level 3; pCodeLevel4: used to select data based on one value at level 4; •pCodeLevel5: used to select data based on one value at level 5; pLegislationCode: used to select data based on legislation; pLegislativeDataGroupId: used to select data based on one legislative data group; and/or pLegLdgId: used to select data based on the legislation of one legislative data group. Another view criterion can be used in order to provide direct selection of one code, based on: pCode: used to select one code. Examples for the US localization include: oracle.apps.hcm.locUS.payrollSetup.details.publicView.UsStatePVO: used to select the list of US states; oracle.apps.hcm.locUS.payrollSetup.details.publicView.UsCountyPVO: used to select the list of counties in a one given US state; and oracle.apps.hcm.locUS.payrollSetup.details.publicView.UsCityPVO: used to select the list of cities in one given county in one given US state.

In one embodiment, deduction groups are defined within the DIR by core payroll but localizations have to enable the deduction groups they want to consume in legislation. Thus, elements or calculations that cannot be identified within an existing deduction group can be excluded from the localization uptake process. Conversely, elements or calculations that can be identified within a deduction group can be considered for the uptake. Several deduction groups (e.g., federal, regional, retirement plans, social insurance, taxes, loans, charitable donations, benefits, union, employer reimbursements, stock, involuntary deductions, and the like) are seeded by core payroll. Because deductions do not replace elements but group together several elements (as components) in order to drive calculations, the identification of deductions that are candidates for the uptake can be based on elements already defined in the system. To enable particular deduction groups (tables PAY_DEDUCTION_GROUPS and PAY_DEDUCTION_GROUPS_TL) for a particular localization, the particular deduction groups are seeded for the appropriate legislation (column LEGISLATION_CODE) as extension of core groups (using column BASE_DEDUCTION_GROUP_ID).

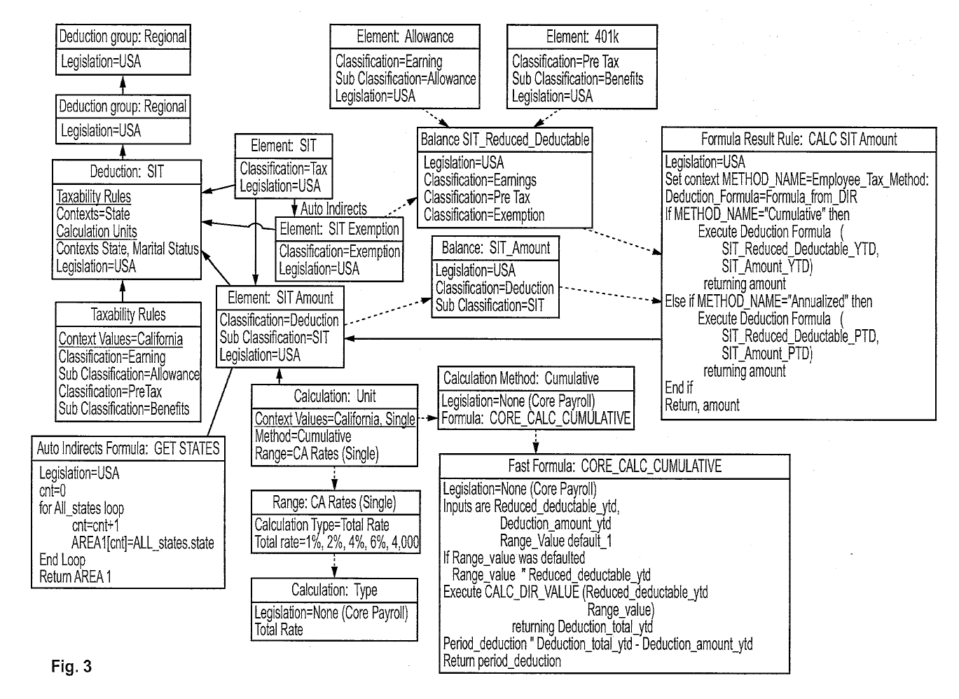

In order to provide better explanations, one particular example (illustrated in FIG. 3) is referred to throughout this disclosure. This example is a very simplified example defined for use in a United States (US) company. At high level, the example is based on the implementation of State Income Tax (SIT) calculation. One deduction is defined in order to make the calculation of taxable amounts, exemptions, and tax amounts. Taxability rules/wage basis rules about earnings, pre-tax deductions, and exemptions are defined for every state. Calculation rules are also defined for various tax methods, for every state, and for different marital statuses. The calculations refer to tax tables defined for every state and various combinations of tax methods and marital statuses.

As shown in FIG. 3, the deduction group ‘Regional’ is enabled for the US. Additionally, one deduction is designed for state income tax calculation. This deduction is included into the ‘Regional’ deduction group. Taxability and calculation rules vary from one state to another, and in addition, the calculations may depend on marital status.

The state income tax calculation requires calculating the same deduction (composed of an exemption and then an amount) for all the states the employee worked in. One element ‘SIT’ is defined with auto-indirects in order to trigger the calculation of the exemption ‘SIT Exemption’, then the deduction amount ‘SIT Amount’. One auto-indirect fast formula ‘GET_STATES’ insures one calculation is triggered per state. The formula is, for example, based on a database item that retrieves the states the employee worked in during the year. The three elements are all attached to the same deduction.

In the example of state income tax for the US, the calculations of the deductable amounts are based on balances that include earnings, pre-tax deductions and exemptions. Then, variations for different states are recorded as taxability rules and/or wage basis rules (including or not sub-classifications for the classifications to be considered).

Deduction ranges are defined for every state income tax table. Sometimes tables are split into two deduction ranges or more when rates or values depend on the marital status or the tax method. For almost all the deduction ranges, the standard core payroll calculation types are used (mostly ‘flat amount’ or ‘flat amount times multiplier’ for tax exemptions, ‘flat rate’ for tax amounts).

Calculations of state income tax are sometimes based on a year-to-date basis or period-to-date basis, and sometimes based on a proration factor (period number). Three tax methods are required: annualized, cumulative and supplemental. The method to be used for the calculation can depend on the employee category (for instance, sales people are not taxed the same way as the other employees) or depend on the run type (for instance, in some states the bonuses are not taxed the same way as the regular earnings if the bonuses are paid separately). The calculation methods are defined using the standard core payroll formulas.

The calculation units/factors depend on the tax method. They are different from one state to another and sometimes depend on the marital status, too.

The formula defined as a result rule for the tax amount retrieves the method to be used based on employee data, then triggers the calculation using a core database item that returns the formula attached to the appropriate calculation unit/factor. Depending on the method, the calculation is based on one set of balances or another (sometimes PTDs, sometimes YTDs are required).

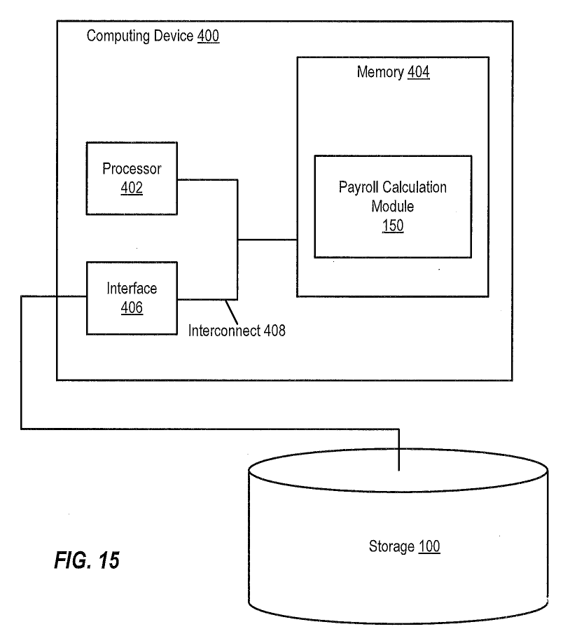

FIG. 15 is a block diagram of a computing device 400 that illustrates how a system that includes a DIR can be implemented in software. Computing device 400 can be a personal computer, network appliance, server, personal digital assistant, mobile phone, storage controller (e.g., an array controller, tape drive controller, or hard drive controller), laptop computer, or the like. In general, computing device 400 is configured to execute software or otherwise provide appropriate functionality as described herein.

As illustrated, computing device 400 includes one or more processors 402 (e.g., microprocessors, Programmable Logic Devices (PLDs), or Application Specific Integrated Circuits (ASICs)) configured to execute program instructions stored in memory 404. Memory 404 can include various types of Random Access Memory (RAM), Read Only Memory (ROM), Flash memory, Micro Electro-Mechanical Systems (MEMS) memory, magnetic core memory, and the like. Memory 404 can include both volatile and non-volatile memory.

Computing device 400 also includes one or more interfaces 406 (e.g., such as interfaces to a storage device, network, user output device such as a display device, user input device such as a mouse, touch screen, or keyboard, and the like). Processor 402, interface 406, and memory 404 are coupled to send and receive data and control signals by a bus or other interconnect.

Interface 406 can include a network interface to various networks and/or interfaces to various peripheral buses. Interface 406 can also include an interface to one or more storage devices (e.g., such as a storage device, like storage 100 of FIG. 1).

In this example, program instructions and data executable to implement all or part of payroll calculation module 150 are stored in memory 404. The program instructions and data implementing payroll calculation module 150 can be stored on various computer readable storage media such as memory 404. In some embodiments, such software is stored on a computer readable storage medium such as a Compact Disc (CD), Digital Versatile Disc (DVD), hard disk, optical disk, tape device, floppy disk, and the like). In order to be executed by processor 402, the instructions and data can be loaded into memory 404 from the other computer readable storage medium. The instructions and/or data can also be transferred to computing device 400 for storage in memory 404 via a network such as the Internet or upon a carrier medium.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer-implemented method comprising:
retrieving a template from one or more repositories, wherein
a payroll procedure comprises
a payroll task,
the template is an abstract representation of the payroll task, and
the payroll task comprises
a payroll operation of a plurality of payroll operations;
modifying the template; and
storing the template in the repository.
